(19) United States
(12) Patent Application Publication
(10) Pub. No.: US 2026/0181374 A1
(43) Pub. Date: Jun. 25, 2026

(54) METHOD AND APPARATUS FOR MANAGING FORBIDDEN TRACKING AREAS IN COMMUNICATION NETWORK

(71) Applicant: Samsung Electronics Co., Ltd., Suwon-si, Gyeonggi-do (KR)

(72) Inventors: Danish Ehsan HASHMI, Bangalore (IN); Lalith KUMAR, Bangalore (IN); Koustav ROY, Bangalore (IN); Jagadeesh GANDIKOTA, Bangalore (IN)

(21) Appl. No.: 19/126,496

(22) PCT Filed: Nov. 3, 2023
(86) PCT No.: PCT/KR2023/017483

§ 371 Date: May 1, 2025

(30) Foreign Application Priority Data
Nov. 4, 2022 (IN) 202241062988
Oct. 20, 2023 (IN) 202241062988

(51) Int. Cl. H04W 8/02

(52) U.S. Cl. CPC H04W 8/02

(57) ABSTRACT

The disclosure relates to a 5G or 6G communication system for supporting a higher data transmission rate. The present disclosure relates to method and apparatus for managing forbidden tracking areas in communication network. The method comprises receiving, from an access and mobility function (AMF), a reject message including a rejection cause regarding an access to at least one network slice, wherein the UE is camped on a first tracking area of a plurality of tracking areas associated with a public land mobile network (PLMN), and wherein the rejection cause is based on an error indicating unavailability of the at least one network slice in the first tracking area; storing information of the first tracking area in a list of forbidden tracking areas for the UE; and recording the error while storing the information of the first tracking area in the list of forbidden tracking areas for the UE.

### CROSS-REFERENCE TO RELATED APPLICATION(S)

This application is a U.S. National Stage application under 35 U.S.C. § 371 of an International application number PCT/KR 2023/017483, filed on Nov. 3, 2023, which is based on and claims priority of an Indian patent application number 202241062988, filed on Nov. 4, 2022, in the Indian Intellectual Property Office, and of an Indian patent application number 202241062988, filed on Oct. 20, 2023, in the Indian Intellectual Property Office, the disclosure of each of which is incorporated by reference herein in its entirety.

### TECHNICAL FIELD

The present disclosure generally relates to communication networks. More particularly, the present disclosure relates to a method and a user equipment (UE) for managing forbidden tracking areas in communication networks.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Over time, communication networks have undergone significant evolution, advancing to accommodate diverse communication services, varying traffic loads, and serving distinct user communities. The concept of network slicing has emerged as a pivotal technology in modern communication networks, enabling creation of virtual networks tailored to meet specific requirements of various communication services. The objective of network slicing is to provide optimized support for a wide range of communication services.

Devices connect to the communication network based on geographical areas in which the devices are located, referred as tracking areas. Notably, each tracking area comprises an identity within the communication network, referred as a tracking area identity, which is used to identify tracking areas. The Tracking Area Identity (TAI) is constructed from the MCC (Mobile Country Code), MNC (Mobile Network Code) and TAC (Tracking Area Code).

When a rejection is received by the devices while connecting to the communication network, the tracking area identity of the tracking area where the device is located gets stored in a list of forbidden tracking areas. This rejection is often received when network slices requested by a device are not available in the tracking area. Currently, in such scenarios, the tracking area identity may get stuck in the list of forbidden tracking areas and there exists no technique to remove the same, even after the cause for rejection has been rectified.

The information disclosed in this background of the disclosure section is only for enhancement of understanding of the general background of the invention and should not be taken as an acknowledgement or any form of suggestion that this information forms the prior art already known to a person skilled in the art.

### DISCLOSURE

### Technical Solution

In an embodiment, the present disclosure discloses a method of managing forbidden tracking areas performed by a user equipment (UE) in communication networks. The method comprises receiving, from an access and mobility function (AMF), a reject message including a rejection cause regarding an access to at least one network slice, wherein the UE is camped on a first tracking area of a plurality of tracking areas associated with a public land mobile network (PLMN), and wherein the rejection cause is based on an error indicating unavailability of the at least one network slice in the first tracking area; storing information of the first tracking area in a list of forbidden tracking areas for the UE; and recording the error while storing the information of the first tracking area in the list of forbidden tracking areas for the UE.

In an embodiment, the present disclosure discloses a user equipment (UE) managing forbidden tracking areas in communication networks. The UE comprises a transceiver; and at least one processor coupled to the transceiver, and configured to:
receive, from an access and mobility function (AMF), a reject message including a rejection cause regarding an access to at least one network slice, wherein the UE is camped on a first tracking area of a plurality of tracking areas associated with a public land mobile network (PLMN), and wherein the rejection cause is based on an error indicating unavailability of the at least one network slice in the first tracking area, store information of the first tracking area in a list of forbidden tracking areas for the UE, and record the error while storing the information of the first tracking area in the list of forbidden tracking areas for the UE.

In an embodiment, the present disclosure discloses a method of managing forbidden tracking areas in communication networks. The method comprises receiving, by a User Equipment (UE) camped on a first tracking area of a plurality of tracking areas associated with a Public Land Mobile Network (PLMN), a rejection cause in response to a first request to access one or more network slices from an Access and Mobility Function (AMF) associated with the PLMN. Herein, the rejection cause is based on an error indicating unavailability of the one or more network slices in the first tracking area. The method comprises recording the error while storing the first tracking area in a list of forbidden tracking areas for the UE. The method comprises registering the UE with the PLMN for a second tracking area from the plurality of tracking areas, based on a confirmation by the AMF on a second request to access the one or more network slices. The method further comprises receiving an update from the AMF regarding a change in subscription of the one or more network slices The method further comprises removing the first tracking area associated with the error from the list of forbidden tracking areas, based on the update, to manage the forbidden tracking areas.

In an embodiment, the present disclosure discloses a user equipment (UE) for managing forbidden tracking areas in communication networks. The UE comprises one or more processors and a memory, the memory being communicatively coupled to the processor. Further, the memory stores processor-executable instructions, which, on execution, cause the one or more processors to perform steps associated with the present disclosure. Herein, the processor is configured to receive, when the UE is camped on a first tracking area of a plurality of tracking areas associated with a Public Land Mobile Network (PLMN), a rejection cause in response to a first request to access one or more network slices from an Access and Mobility Function (AMF) associated with the PLMN. Herein, the rejection cause is based on an error indicating unavailability of the one or more network slices in the first tracking area. Further, the processor is configured to record the error while storing the first tracking area in a list of forbidden tracking areas for the UE. Further, the processor is configured to register with the PLMN for a second tracking area from the plurality of tracking areas, based on a confirmation by the AMF on a second request to access the one or more network slices. Further, the processor is configured to receive an update from the AMF regarding a change in availability of the one or more network slices in the second tracking area. Further, the processor is configured to remove the first tracking area associated with the error from the list of forbidden tracking areas, based on the update, to manage the forbidden tracking areas.

The foregoing summary is illustrative only and is not intended to be in any way limiting. In addition to the illustrative aspects, embodiments, and features described above, further aspects, embodiments, and features will become apparent by reference to the drawings and the following detailed description.

### DESCRIPTION OF DRAWINGS

The novel features and characteristics of the disclosure are set forth in the appended claims. The disclosure itself, however, as well as a preferred mode of use, further objectives, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates an exemplary environment for managing forbidden tracking areas in communication networks, in accordance with some embodiments of the present disclosure;

FIG. 2 illustrates a detailed diagram of a user equipment (UE), in accordance with some embodiments of the present disclosure;

FIG. 3 shows an exemplary flow chart illustrating method steps for managing forbidden tracking areas in communication networks, in accordance with some embodiments of the present disclosure;

FIGS. 4a and 4b show exemplary sequence diagrams illustrating steps for managing forbidden tracking areas in communication networks, in accordance with some embodiments of the present disclosure; and

FIG. 5 illustrates a block diagram of an exemplary computer system for implementing embodiments consistent with the present disclosure.

It should be appreciated by those skilled in the art that any block diagram herein represents conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### MODE FOR INVENTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure discloses a method and a device for managing forbidden tracking areas in communication networks. In current communication systems (For example, 5^{th} Generation New Radio (5G NR)), there is no provision for managing a list of forbidden tracking areas which have been previously rejected for connection by the communication network. Therefore, to overcome this, the present disclosure records an error indicating unavailability of the one or more network slices in tracking areas while storing the tracking areas in a list of forbidden tracking areas for the UE. Then, the present disclosure includes removing previously rejected tracking areas from the list of forbidden tracking areas when updates regarding the communication network indicate that the cause for rejection is resolved. Advantageously, the present disclosure provides efficient communication services to user devices. Moreover, the present disclosure ensures fast and reliable services based on the tracking area of the user devices. As a result, overall efficiency of the communication network improves, ensuring superior service delivery and optimized network performance.

The present disclosure is explained with the help of figures. However, such exemplary embodiments should not be construed as limitations of the present disclosure since the method as disclosed may be used or employed for any system for logging events in communication networks. A person skilled in the art may envisage various such embodiments without deviating from scope of the present disclosure.

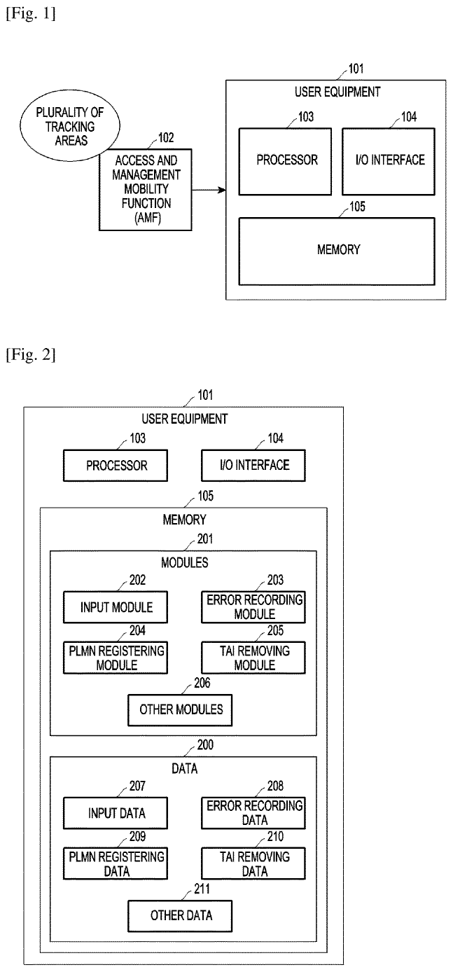

FIG. 1 illustrates an exemplary environment for managing forbidden tracking areas in communication networks, in accordance with some embodiments of the present disclosure.

As shown in FIG. 1, an exemplary environment 100 includes a User Equipment (UE) 101 associated with a Public Land Mobile Network (PLMN) and in communication with an Access and Mobility Function (AMF) 102 associated with the PLMN. The PLMN refers to the communication network which offers mobile communication services to public. The PLMN includes various components such as, but not limited to, base stations, mobile switching centres, and core network elements that enable wireless communication services, including voice calls, messaging, and data transfer, to mobile devices within a specific geographical area. A network function is defined as a specialized component within a communication network responsible for performing specific tasks, such as routing, switching, security, load balancing, quality of service management, or network address translation (NAT). These network functions are fundamental to the operation and efficiency of modern communication networks, enabling seamless processing, management, and forwarding of data packets to support diverse communication services and ensure optimal network performance. Notably, the AMF 102 is a network function which is responsible for managing connection, user access and mobility tasks within the communication network. For example, the AMF 102 may handle procedures related to initial access, mobility management, and session management for user devices, ensuring seamless connectivity and efficient service delivery in the communication network.

The UE 101 enables efficient management of forbidden tracking areas in a communication network. The UE 101 may include, but not limited to, a laptop computer, a desktop computer, a Personal Computer (PC), a notebook, a smartphone, a tablet, a server, a network server, a cloud-based server, and the like. In an embodiment, the UE 101 may be implemented as a hand-held mobile communication device akin to a mobile phone.

The UE 101 may include a processor 103, a I/O interface 104, and the memory 105. In some embodiments, the memory 105 may be communicatively coupled to the processor 103. The memory 105 stores instructions, executable by the processor 103, which, on execution, may cause the UE 101 to manage the forbidden tracking areas in the communication network, as disclosed in the present disclosure.

The UE 101 may communicate with the AMF 102 via N1 interface. N1 interface is used to transfer NAS (non-access stratum) message between UE and the AMF 102 (for example, NAS message related to connection, mobility, and sessions).

Herein, the UE 101 is camped on a first tracking area of a plurality of tracking areas associated with the PLMN. A Tracking Area (TA) refers to a geographical area comprising one or more cells within which a mobile device (for example, the UE 101) can move without triggering registration request once registered. Typically, the UE 101 may move between cells instead of updating the communication network about their location every time. Herein, devices such as the UE 101 may update the communication network about current location only when they move across tracking area boundaries (UE move to TA, which is not in the TAI list). This advantageously reduces signalling overhead and enhances network efficiency. Notable, when the UE 101 is camped on the first tracking area, it refers to the UE 101 being located in the geographical area corresponding to the first tracking area.

Herein, the UE 101 may request the AMF 102 for various services by requesting access to one or more network slices. The term “network slice” refers to logically isolated and independent virtual networks created within the communication network. Each network slice is tailored to specific requirements, applications, or services, offering customized levels of performance, resources, and functionalities. This enables multiple diverse use cases, such as enhanced mobile broadband, massive IoT, and critical communications, to coexist on the same underlying infrastructure while maintaining their distinct characteristics and quality of service. The network slice is identified by S-NSSAI (Single-Network Slice Selection Assistance Information).

The UE 101 may send a first request to the AMF 102 for connecting to the PLMN via the first tracking area. Herein, the UE 101 may send the first request to access the one or more network slices of a plurality of network slices associated with the communication network. However, a rejection cause may be sent from the AMF 102 to the UE 101 when certain requested slice(s) are unavailable in the first tracking area. Herein, the rejection cause is based on an error indicating unavailability of the one or more network slices in the first tracking area. It will be appreciated that based on various implementations of the present disclosure, the error may vary and that the solutions consistent with the present disclosure may be implemented even with other implementations of the error.

In an embodiment, rejection cause from AMF 102 is provided as a REGISTRATION REJECT or Network initiated DEREGISTRATION REQUEST COMMAND comprising 5GMM cause set to #62 (No network slice available) and rejected NSSAI IE with at least one rejection cause in the rejected S-NSSAI(s) is set to “S-NSSAI not available in the current PLMN or SNPN” Thereafter, the UE 101 of the present disclosure records the error while storing the first tracking area in a list of forbidden tracking areas for the UE 101. The list of forbidden tracking areas refers to a list which is used to manage the mobility of the UE 101. The list of forbidden tracking areas contains Tracking Area Identities (TAIs) that the UE 101 avoids when initiating or updating its location with the communication network. The communication network provides this list to the UE 101 to prevent it from attempting to connect to certain tracking areas, which might have poor signal quality, congestion, or other issues. This helps improve network efficiency and user experience by guiding mobility behaviour of the UE 101. Notably, each UE maintains individual lists of forbidden tracking areas.

Further, the UE 101 of the present disclosure registers with the PLMN for a second tracking area from the plurality of tracking areas, based on a confirmation by the AMF on a second request to access the one or more network slices. Herein, the UE 101 searches the plurality of tracking areas excluding the first tracking area, to access the one or more network slices. Once the UE 101 finds the second tracking area to access the one or more network slices, the UE 101 sends the second request to access the one or more network slices to the AMF 102. Herein, the UE 101 is camped on the second tracking area from the plurality of tracking areas. The UE 101 may receive a confirmation in response to the second request from the AMF 102. Based on the confirmation, the UE 101 registers with the PLMN for the second tracking area.

Thereafter, the UE 101 may receive an update from the AMF 102 regarding a change in a subscription of the one or more network slices. Notably, the AMF 102 shares updates regarding network slicing subscription changes with the UE 101.

In an embodiment, the update from the AMF 102 regarding the change in the subscription of the one or more network slices is provided as a CONFIGURATION UPDATE COMMAND or REGISTRATION ACCEPT message comprising a network slicing indication Information Element (IE) indicating a change in subscription of the one or more network slices.

In another embodiment, the update from the AMF 102 regarding the change in the subscription of the one or more network slices is provided as a CONFIGURATION UPDATE COMMAND or REGISTRATION ACCEPT message comprising network slicing configuration information indicating at least one of: an allowed Network Slice Selection Assistance Information (NSSAI) and a configured NSSAI, wherein each NSSAI corresponds to the one or more network slices.

Eventually, the UE 101 removes the first tracking area associated with the error from the list of forbidden tracking areas, based on the update, to manage the forbidden tracking areas. Advantageously, this allows the UE 101 to connect to the communication network via the first tracking area when the UE 101 is present in the first tracking area, ensuring efficient service delivery to the UE 101.

After removing the first tracking area from the list of forbidden tracking areas, the UE 101 may connect with the PLMN via the first tracking area to access the one or more network slices. Herein, the UE 101 sends a third request to access the one or more network slices in the first tracking area, to the AMF 102. In response to the third request, the UE 101 may receive a confirmation from the AMF 102. Thereafter, the UE 101 may register with the PLMN for the first tracking area, based on the confirmation.

FIG. 2 illustrates a detailed diagram of the User Equipment (UE) 101, in accordance with some embodiments of the present disclosure.

Data 200 and one or more modules 201 in the memory 105 of the UE 101 is described herein in detail.

In an embodiment, the data 200 in the memory 105 may be processed by the one or more modules 201 of the UE 101. The one or more modules 201 may be configured to perform the steps of the present disclosure using the data 200, for managing forbidden tracking areas in communication networks. In an embodiment, each of the one or more modules 201 may be a hardware unit which may be outside the memory 105 and coupled with the UE 101. In an embodiment, the one or more modules 201 may be implemented as dedicated units and when implemented in such a manner, said modules may be configured with the functionality defined in the present disclosure to result in a novel hardware. As used herein, the term module may refer to an Application Specific Integrated Circuit (ASIC), an electronic circuit, a Field-Programmable Gate Arrays (FPGA), Programmable System-on-Chip (PSoC), a combinational logic circuit, and/or other suitable components that provide the described functionality.

In one implementation, one or more modules 201 may include, but are not limited to, an input module 202, an error recording module 203, a PLMN registering module 204, a TAI removing module 205, and other modules 206, associated with the UE 101.

One or more modules 201 of the UE 101 function to manage forbidden tracking areas in communication networks, based on the data 200. The one or more modules 201 along with the data 200, may be implemented in any communication network, for managing the forbidden tracking areas.

The input module 202 may be configured to receive inputs. In an example, the input module 202 may be configured to receive a rejection cause in response to the first request to access the one or more network slices from the AMF 102 associated with the PLMN. Herein, the rejection may be based on an error. In another example, the input module 202 may be configured to receive an update from the AMF 102 regarding a change in subscription of the one or more network slices.

The error recording module 203 is configured to record the error while storing a tracking area identity in a list of forbidden tracking areas for the UE 101. Particularly, the error recording module 203 may record the error by memorizing the error associated with the current TAI. For example, the error recording module 203 may be configured to record the error while storing the first tracking area in the list of forbidden tracking areas for the UE 101. Herein, the error may indicate unavailability of the one or more network slices in the first tracking area.

The PLMN registering module 204 is configured to register the UE 101 with the PLMN for tracking areas for accessing the one or more network slices. For example, the PLMN registering module 204 may be configured to register the UE 101 with the PLMN for a second tracking area from the plurality of tracking areas, based on a confirmation by the AMF 102 to the second request by the UE 101 to access the one or more network slices. A person skilled in the art may understand that any known protocols and techniques may be used by the PLMN registering module 204 for registering the UE 101 with the PLMN for the tracking areas.

The TAI removing module 205 is configured to remove the tracking area associated with the error from the list of forbidden tracking areas, based on the update received from the AMF 102. For example, the TAI removing module 205 may be configured to remove the first tracking area associated with the error from the list of forbidden tracking areas. The update may indicate a change in subscription of the one or more network slices.

The one or more modules 201 may also include other modules 206 to perform various miscellaneous functionalities of the UE 101.

In an embodiment, the data 200 in the memory 105 may include input data 207, error recording data 208, PLMN registering data 209, TAI removing data 210, and other data 211 associated with the UE 101.

The input data 207 may include communication data received from the AMF 102. The input data 207 comprises confirmation data with respect to one or more requests (the first request, the second request and the third request), rejection information with request to the one or more requests, update-related information, and the like.

The error recording data 208 may include data pertaining to errors received when the UE 101 is unable to connect with the communication network via a particular tracking area. For example, the error recording data 208 may include that the error indicates unavailability of the one or more network slices in the first tracking area.

The PLMN registering data 209 may include data pertaining to registration of the UE 101 with the PLMN. For example, the PLMN registering data 209 may comprise data pertaining to the registration of the UE 101 with the PLMN for the first tracking area, and the second tracking area from the plurality of tracking areas.

The TAI removing data 210 may include data pertaining to removal of tracking areas from the list of forbidden tracking areas. For example, the TAI removing data 210 may include data pertaining to removal of the first tracking area associated with the error from the list of forbidden tracking areas.

The other data 211 may store data, including temporary data and temporary files, generated by modules for performing the various functions of the UE 101. The one or more modules 201 may also include the other modules 206 to perform various miscellaneous functionalities of the UE 101. The other data may be stored in the memory 105. It will be appreciated that the one or more modules 206 may be represented as a single module or a combination of different modules.

In an embodiment, the other modules 206 may include a tracking area searching module, a network update module, and a re-registration module. The tracking area searching module may be configured to search the plurality of tracking areas excluding the first tracking area, to find a tracking area for accessing the one or more network slices. The network update module is configured to store updates received from the AMF 102 regarding a change in subscription of the one or more network slices. The re-registration module is configured to register the UE 101 with the communication network via a tracking area which was previously in the list of forbidden tracking areas. For example, the re-registration module is configured to register the UE 101 with the communication network via the first tracking area when the first tracking area is removed from the list of forbidden tracking areas.

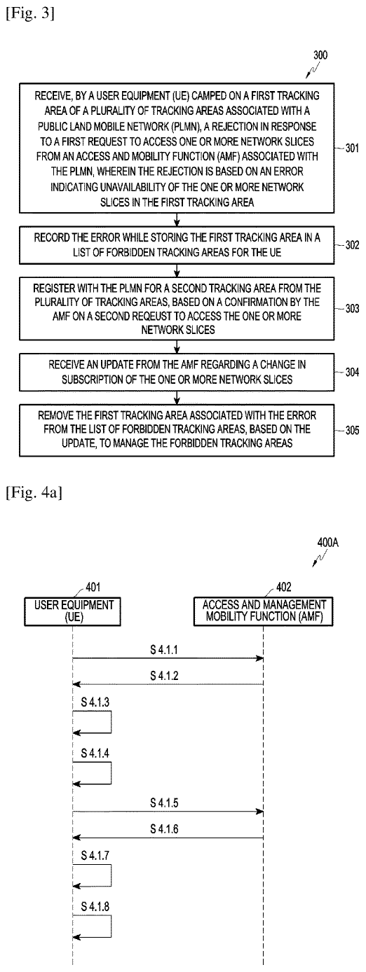

FIG. 3 shows an exemplary flow chart illustrating method steps for managing forbidden tracking areas in communication networks, in accordance with some embodiments of the present disclosure.

As illustrated in FIG. 3, method 300 may comprise one or more steps. The method 300 may be described in the general context of computer executable instructions. Generally, computer executable instructions can include routines, programs, objects, components, data structures, procedures, modules, and functions, which perform particular functions or implement particular abstract data types.

The order in which method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 301, the method comprises receiving by a User Equipment (UE) 101 camped on a first tracking area of a plurality of tracking areas associated with a Public Land Mobile Network (PLMN), a rejection cause in response to a first request to access one or more network slices from an Access and Mobility Function (AMF) 102 associated with the PLMN. Herein, the rejection is based on an error indicating unavailability of the one or more network slices in the first tracking area.

At step 302, the method comprises recording the error while storing the first tracking area in a list of forbidden tracking areas for the UE.

At step 303, the method comprises registering the UE with the PLMN for a second tracking area from the plurality of tracking areas, based on a confirmation by the AMF on a second request to access the one or more network slices.

At step 304, the method comprises receiving an update from the AMF regarding a change in subscription of the one or more network slices.

At step 305, the method comprises removing the first tracking area associated with the error from the list of forbidden tracking areas, based on the update, to manage the forbidden tracking areas.

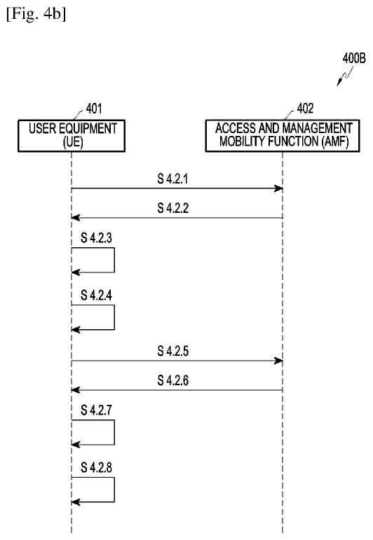

FIGS. 4A and 4B show exemplary sequence diagrams illustrating steps for managing forbidden tracking areas in communication networks, in accordance with some embodiments of the present disclosure.

As illustrated in FIGS. 4A and 4B, methods 400A and 400B, respectively may comprise one or more steps. The methods 400A and 400B may be described in the general context of computer executable instructions. Generally, computer executable instructions can include routines, programs, objects, components, data structures, procedures, modules, and functions, which perform particular functions or implement particular abstract data types.

The order in which methods 400A and 400B are described is not intended to be construed as a limitation, and any number of the described method blocks can be combined in any order to implement the method. Additionally, individual portions may be deleted from the methods without departing from the scope of the subject matter described herein. Furthermore, the method can be implemented in any suitable hardware, software, firmware, or combination thereof.

As shown in FIGS. 4A and 4B, the steps for managing forbidden tracking areas in communication networks are performed by a plurality of entities, including, but not limited to, a User Equipment (UE) 401, and an Access and Management Mobility Function (AMF) 402. The UE 401 and AMF 402 have been defined earlier in this disclosure, in association with FIG. 1.

Referring specifically to FIG. 4A, the figure shows an exemplary sequence diagram 400A illustrating steps for managing forbidden tracking areas in communication networks, wherein the forbidden tracking area is removed after the subscription is changed, in accordance with some embodiments of the present disclosure.

At step S4.1.1, the UE 401 sends a REGISTRATION REQUEST to the AMF 402. Herein, the REGISTRATION REQUEST comprises a requested NSSAI (Network Slice Selection Assistance Information) being set to S-NSSAI-1, associated with a first Public Land Mobile Network (PLMN-1), in a first Tracking Area Identity (TAI-1).

At step S4.1.2, the AMF 402 sends a REGISTRATION REJECT message to the UE 401. Notably, the REGISTRATION REJECT message is a integrity protected message. Herein, the registration is rejected with 5GMM cause value and an error indicating unavailability of the requested network slice (S-NSSAI-1) in the first tracking area (TAI-1). In an exemplary embodiment, the error may be implemented as “S-NSSAI not available in the current registration area” and 5GMM cause may be implemented as #62“No network slices available”. Moreover, all the S-NSSAI(s) in the allowed NSSAI and configured NSSAI are rejected (i.e., there is no S-NSSAI (single-NSSAI) in the allowed list or the configured NSSAI where UE can get the service as all are rejected).

At step S4.1.3, the UE 401 stores the first tracking area identity (TAI-1) in the list of forbidden tracking areas for the UE 401. The list of forbidden tracking areas may be implemented as a list of “5GS forbidden tracking areas for roaming”. Moreover, a state associated with the first tracking area identity is mentioned while storing the same in the list of forbidden tracking areas. The state may be implemented as a state “5GMM-DEREGISTERED. LIMITED-SERVICE” or “5GMM-REGISTERED.LIMITED-SERVICE”.

At step S4.1.4, the UE 401 records the error while storing the first tracking area in the list of forbidden tracking areas for the UE 401. For example, the UE 401 may memorize the first tracking area identity that was stored in the list of “5GS forbidden tracking areas for roaming” for S-NSSAI is rejected due to “S-NSSAI not available in the current registration area”.

At step S4.1.5, the UE 401 searches for other tracking areas in the same PLMN and finds a second tracking area. Herein, the UE 401 registers itself with the first PLMN with the second tracking area (TAI-2) via the AMF 402. The AMF 402 may share an update to the UE 401 regarding a change in subscription of the one or more network slices in REGISTRATION ACCEPT message in network slicing indication IE. Moreover, the update may indicate that the network slicing subscription has changed, for example, Network slicing subscription change indication set to “Network slicing subscription changed” in network slicing indication IE.

At step S4.1.6, the AMF 402 shares an update to the UE 401 regarding a change in subscription of the one or more network slices. The update may be implemented as a CONFIGURATION UPDATE COMMAND message in network slicing indication IE. Moreover, the update may indicate that the network slicing subscription has changed, for example, in network slicing indication IE, Network slicing subscription change indication set to “Network slicing subscription changed”.

At step S4.1.7, the UE 401 removes the first tracking area (TAI-1) from the list of forbidden tracking areas (5GS forbidden tracking areas for roaming) after the network slice subscription changes.

At step S4.1.8, the UE 401 removes any and all tracking areas from the list of forbidden tracking areas when associated network slice subscription changes. For example, the UE 401 shall remove all TAIs from the list of “5GS forbidden tracking areas for roaming” which have been put into “5GS forbidden tracking areas for roaming” for S-NSSAI-1 is rejected due to “S-NSSAI not available in the current registration area” (the UE 401 previously stored the first tracking area in the list of “5GS forbidden tracking areas for roaming” since S-NSSAI was rejected due to “S-NSSAI not available in the current registration area”) after subscription has been changed.

Referring specifically to FIG. 4B, the figure shows an exemplary sequence diagram 400B illustrating steps for managing forbidden tracking areas in communication networks, wherein the forbidden tracking area is removed after an allowed network slice, a configured network slice, or both changes, in accordance with some embodiments of the present disclosure.

At step S4.2.1, the UE 401 sends a registration request to the AMF 402. Herein, the registration request comprises a requested Network Slice Selection Assistance Information (NSSAI) being set to S-NSSAI-1, associated with a first Public Land Mobile Network (PLMN-1), in a first Tracking Area Identity (TAI-1).

At step S4.2.2, the AMF 402 sends a REGISTRATION REJECT message to the UE 401. Notably, the REGISTRATION REJECT message is a protected message. Herein, the registration is rejected with 5GMM cause value and an error indicating unavailability of the requested network slice (S-NSSAI-1) in the first tracking area (TAI-1). In an exemplary embodiment, the error may be implemented as “S-NSSAI not available in the current registration area” and 5GMM cause value #62(No network slices available). Moreover, all the S-NSSAI(s) in the allowed NSSAI and configured NSSAI are rejected (i.e., there is no S-NSSAI (single-NSSAI) in the allowed list or the configured NSSAI where UE can get the service as all are rejected)

At step S4.2.3, the UE 401 stores the first tracking area identity (TAI-1) in the list of forbidden tracking areas for the UE 401. The list of forbidden tracking areas may be implemented as a list of “5GS forbidden tracking areas for roaming”. Moreover, a state associated with the first tracking area identity is mentioned while storing the same in the list of forbidden tracking areas. The state may be implemented as a state “5GMM-DEREGISTERED. LIMITED-SERVICE” or “5GMM-REGISTERED. LIMITED-SERVICE”.

At step S4.2.4, the UE 401 records the the error while storing the first tracking area in the list of forbidden tracking areas for the UE 401. For example, the UE 401 may memorize the first tracking area identity that was stored in the list of “5GS forbidden tracking areas for roaming” for S-NSSAI is rejected due to “S-NSSAI not available in the current registration area” (optionally only if the rejection cause in the rejected S-NSSAI(s) is “S-NSSAI not available in the current registration area”).

At step S4.2.5, the UE 401 searches for other tracking areas in the same PLMN and finds a second tracking area. Herein, the UE 401 registers itself with the first PLMN with the second tracking area (TAI-2) via the AMF 402. The AMF 402 may share an update to the UE 401 regarding a change in subscription of the one or more network slicesin REGISTRATION ACCEPT message. Moreover, the update may comprise an allowed network slice, a configured network slice, or both (optionally attest one S-NSSAI in allowed NSSAI or configured NSSAI is not in rejected NSSAI).

At step S4.2.6, the AMF 402 shares an update to the UE 401 regarding a change in subscription of the one or more network slices. The update may be implemented as a CONFIGURATION UPDATE COMMAND message. Moreover, the update may comprise an allowed network slice, a configured network slice, or both (optionally at least one S-NSSAI in allowed NSSAI or configured NSSAI is not in rejected NSSAI)

At step S4.2.7, the UE 401 removes the first tracking area (TAI-1) from the list of forbidden tracking areas (5GS forbidden tracking areas for roaming) after the allowed network slice, the configured network slice, or both change(s).

At step S4.2.8, the UE 401 may remove any and all tracking areas from the list of forbidden tracking areas when the allowed network slice, the configured network slice, or both change(s). For example, the UE 401 shall remove all TAIs from the list of “5GS forbidden tracking areas for roaming” which have been put into “5GS forbidden tracking areas for roaming” for S-NSSAI-1 is rejected due to “S-NSSAI not available in the current registration area” (since the UE 401 had stored the first tracking area in the list of “5GS forbidden tracking areas for roaming” since S-NSSAI was rejected due to “S-NSSAI not available in the current registration area”) after the allowed network slice, the configured network slice, or both have changed.

Notably, steps S4.2.1, S4.2.2, S4.2.3, S4.2.5 and S4.2.6 cover features associated with prior art, wherein the UE 401 continues to store the first tracking area (TAI-1) in the list of forbidden tracking areas even after network slice subscription or the network slice itself has changed. This is detrimental as it does not allow the UE 401 to connect to the PLMN via the first tracking area and results in inefficient service provided to the UE 401 by the communication network. However, the solution presented in the present disclosure is covered with respect to steps S4.2.4, S4.2.7 and S4.2.8. Herein, the first tracking area is removed from the list of forbidden tracking areas of the UE 401, when intimation is provided from the AMF 402, that the allowed network slice, the configured network slice, or both have changed.

In this embodiment, if UE 401 receive REGISTRATION REJECT or Network initiated DEREGISTRATION REQUEST with 5GMM cause value #62 and if all the S-NSSAI(s) in the default configured NSSAI or configured NSSAI and allowed NSSAI are rejected and at least one S-NSSAI is rejected due to “S-NSSAI not available in the current registration area” then UE 401 may memorize the current TAI was stored in the list of “5GS forbidden tracking areas for roaming” for S-NSSAI is rejected due to “S-NSSAI not available in the current registration area”.

In this embodiment, If the UE 401 receives the Network slicing indication IE in the CONFIGURATION UPDATE COMMAND or REGISTRATION ACCEPT message with the Network slicing subscription change indication set to “Network slicing subscription changed” then it removes all tracking areas from the list of “5GS forbidden tracking areas for roaming” which were added due to rejection of S-NSSAI due to “S-NSSAI not available in the current registration area”.

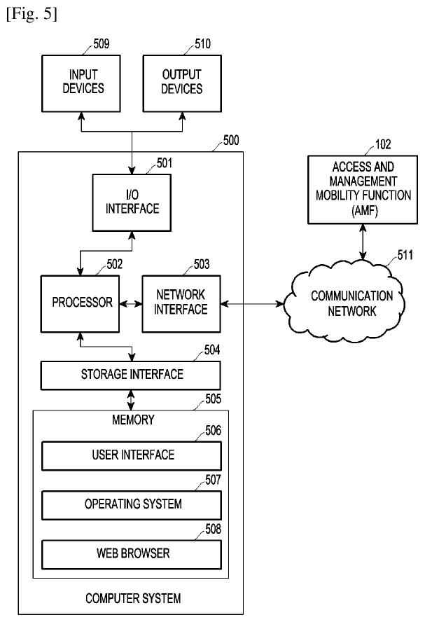

FIG. 5 illustrates a block diagram of an exemplary computer system for implementing embodiments consistent with the present disclosure.

In an embodiment, the computer system 500 is used to implement the user equipment 101 for managing forbidden tracking areas in communication networks. The computer system 500 may include a central processing unit (“CPU” or “processor”) 502. The processor 502 may include at least one data processor for executing processes in Virtual Storage Area Network. The processor 502 may include specialized processing units such as, integrated system (bus) controllers, memory management control units, floating point units, graphics processing units, digital signal processing units, etc.

The processor 502 may be disposed in communication with one or more input/output (I/O) devices 509 and 510 via I/O interface 501. The I/O interface 501 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices, input devices 509 and output devices 510. For example, the input devices 509 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 510 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 500 implements the user equipment 101 for managing forbidden tracking areas in communication networks. The processor 502 may be disposed in communication with the communication network 511 via a network interface 503. The network interface 503 may communicate with the communication network 511. The network interface 503 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 511 may include, without limitation, a direct interconnection, local area network (LAN), wide area network (WAN), wireless network (e.g., using Wireless Application Protocol), the Internet, etc. Using the network interface 503 and the communication network 511, the computer system 500 may communicate with the one or more processors 103 for managing forbidden tracking areas in communication networks. The network interface 503 may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 511 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as, serial advanced technology attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface 506, an operating system 507 etc. In some embodiments, computer system 500 may store user/application data, such as, the data, variables, records, etc., as described in this disclosure. Such databases may be implemented as fault-tolerant, relational, scalable, secure databases such as Oracle ® or Sybase®.

The operating system 507 may facilitate resource management and operation of the computer system 500. Examples of operating systems include, without limitation, APPLE MACINTOSH® OS X, UNIX®, UNIX-like system distributions (E.G., BERKELEY SOFTWARE DISTRIBUTIONTM (BSD), FREEBSDTM, NETBSDTM, OPENBSDTM, etc.), LINUX DISTRIBUTIONSTM (E.G., RED HATTM, UBUNTUTM, KUBUNTUTM, etc.), IBMTM OS/2, MICROSOFTTM WINDOWSTM (XPTM, VISTATM/7/8, 10 etc.), APPLE® IOSTM, GOOGLE® ANDROIDTM, BLACKBERRY® OS, or the like.

In some embodiments, the computer system 500 may implement a web browser 508 stored program component. The web browser 508 may be a hypertext viewing application, such as Microsoft Internet Explorer, Google Chrome, Mozilla Firefox, Apple Safari, etc. Secure web browsing may be provided using Hypertext Transport Protocol Secure (HTTPS), Secure Sockets Layer (SSL), Transport Layer Security (TLS), etc. Web browser 508 may utilize facilities such as AJAX, DHTML, Adobe Flash, JavaScript, Java, Application Programming Interfaces (APIs), etc. In some embodiments, the computer system 500 may implement a mail server stored program component. The mail server may be an Internet mail server such as Microsoft Exchange, or the like. The mail server may utilize facilities such as ASP, ActiveX, ANSI C++/C #, Microsoft . NET, Common Gateway Interface (CGI) scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 500 may implement a mail client stored program component. The mail client may be a mail viewing application, such as Apple Mail, Microsoft Entourage, Microsoft Outlook, Mozilla Thunderbird, etc.

In an embodiment, the present disclosure discloses a method of managing forbidden tracking areas performed by a user equipment (UE) in communication networks. The method comprises receiving, from an access and mobility function (AMF), a reject message including a rejection cause regarding an access to at least one network slice, wherein the UE is camped on a first tracking area of a plurality of tracking areas associated with a public land mobile network (PLMN), and wherein the rejection cause is based on an error indicating unavailability of the at least one network slice in the first tracking area; storing information of the first tracking area in a list of forbidden tracking areas for the UE; and recording the error while storing the information of the first tracking area in the list of forbidden tracking areas for the UE.

In an embodiment, the method further comprises registering with the PLMN for a second tracking area from the plurality of tracking areas, based on a confirmation by the AMF on a request to access the at least one network slice; receiving, from the AMF, an update message regarding a change in subscription of the at least one network slice; and removing the information of the first tracking area associated with the error from the list of forbidden tracking areas, based on the update.

In an embodiment, the reject message comprises a registration reject message or network initiated deregistration request message, and wherein the error comprises all the single-network slice selection assistance information (S-NSSAI)s in the allowed NSSAI and configured NSSAI are rejected and at least one S-NSSAI is rejected due to “S-NSSAI not available in the first tracking area ”.

In an embodiment, the method further comprises searching the plurality of tracking areas excluding the first tracking area, to access the at least one network slice, prior to registering with the PLMN for the second tracking area.

In an embodiment, the update message comprises a configuration update command including a network slicing indication information element (IE) indicating a change in subscription of the at least one network slice.

In an embodiment, the update message comprises a configuration update command message comprising network slicing configuration information indicating at least one of: an allowed network slice selection assistance information (NSSAI) and a configured NSSAI, and each NSSAI corresponds to the at least one network slice.

In an embodiment, the method of registering the user equipment with the PLMN for the second tracking area comprises: transmitting, to the AMF, the request to access the at least one network slice, wherein the UE is camped on the second tracking area from the plurality of tracking areas; receiving, from the AMF, the confirmation in response to the request from the AMF; and registering with the PLMN for the second tracking area, based on the confirmation.

In an embodiment, the present disclosure discloses a user equipment (UE) managing forbidden tracking areas in communication networks. The UE comprises a transceiver; and at least one processor coupled to the transceiver, and configured to: receive, from an access and mobility function (AMF), a reject message including a rejection cause regarding an access to at least one network slice, wherein the UE is camped on a first tracking area of a plurality of tracking areas associated with a public land mobile network (PLMN), and wherein the rejection cause is based on an error indicating unavailability of the at least one network slice in the first tracking area, store information of the first tracking area in a list of forbidden tracking areas for the UE, and record the error while storing the information of the first tracking area in the list of forbidden tracking areas for the UE.

The method and the system for managing forbidden tracking areas in communication networks as disclosed in the present disclosure have several inherent advantages.

In an embodiment, the present disclosure facilitates connection of user devices with the communication network via appropriate tracking areas.

In an embodiment, the present disclosure improves time and resource usage efficiency within the communication network, since appropriate tracking areas are available for connection to user devices, thereby improving overall efficiency of the communication network.

In an embodiment, the present disclosure allows the UE to detect the subscription change and unblock the UE from moving to TAI which is allowed by the subscription.

In an embodiment, the present disclosure improves overall network efficiency, ensuring superior service delivery and optimized network performance.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 3, 4A and 4B show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. A method of managing forbidden tracking areas performed by a user equipment (UE) in communication networks, the method comprising:
receiving, from an access and mobility management function (AMF), a message including a rejection cause regarding an access to at least one network slice,
wherein the UE is camped on a first tracking area of a plurality of tracking areas associated with a public land mobile network (PLMN), and
wherein the rejection cause is based on an error indicating unavailability of the at least one network slice in the first tracking area;
storing information on the first tracking area in a list of forbidden tracking areas for the UE; and
memorizing the error while storing the information on the first tracking area in the list of forbidden tracking areas for the UE.

2. The method of claim 1, further comprising:
registering with the PLMN for a second tracking area from the plurality of tracking areas;
receiving, from the AMF, an update message including an indication indicating subscription change of the at least one network slice; and
removing the information on the first tracking area associated with the error from the list of forbidden tracking areas, based on the indication.

3. The method of claim 1, wherein the message includes a registration reject message and network-initiated deregistration request message, and
wherein the error includes all the single-network slice selection assistance information (S-NSSAI)s in allowed NSSAI and configured NSSAI are rejected and at least one S-NSSAI is rejected due to “S-NSSAI not available in the first tracking area ”.

4. The method of claim 2, wherein prior to registering with the PLMN for the second tracking area, the method comprises:
searching the plurality of tracking areas excluding the first tracking area, to access the at least one network slice.

5. The method of claim 2, wherein the update message includes a configuration update command including a network slicing indication information element (IE) indicating the subscription change of the at least one network slice.

6. The method of claim 2,
wherein the update message includes a configuration update command message including network slicing configuration information indicating at least one of: an allowed network slice selection assistance information (NSSAI) and a configured NSSAI, and
wherein each NSSAI corresponds to the at least one network slice.

7. The method of claim 2, wherein registering with the PLMN for the second tracking area comprises:
transmitting, to the AMF, a request to access the at least one network slice, wherein the UE is camped on the second tracking area from the plurality of tracking areas;
receiving, from the AMF, a confirmation in response to the request; and
registering with the PLMN for the second tracking area, based on the confirmation.

8. A user equipment (UE) managing forbidden tracking areas in communication networks, the UE comprising:
a transceiver; and
at least one processor coupled to the transceiver, and configured to:
receive, from an access and mobility management function (AMF), a message including a rejection cause regarding an access to at least one network slice,
wherein the UE is camped on a first tracking area of a plurality of tracking areas associated with a public land mobile network (PLMN), and
wherein the rejection cause is based on an error indicating unavailability of the at least one network slice in the first tracking area,
store information on the first tracking area in a list of forbidden tracking areas for the UE, and
memorize the error while storing the information of the first tracking area in the list of forbidden tracking areas for the UE.

9. The UE of claim 8, wherein the at least one processor is further configured to:
register with the PLMN for a second tracking area from the plurality of tracking areas,
receive, from the AMF, an update message including an indication indicating subscription change of the at least one network slice, and
remove the information on the first tracking area associated with the error from the list of forbidden tracking areas, based on the indication.

10. The UE of claim 8, wherein the message includes a registration reject message or network-initiated deregistration request message, and
wherein the error includes all the single-network slice selection assistance information (S-NSSAI) s in the allowed NSSAI and configured NSSAI are rejected and at least one S-NSSAI is rejected due to “S-NSSAI not available in the first tracking area”.

11. The UE of claim 9, wherein the at least one processor is further configured to:
search the plurality of tracking areas excluding the first tracking area, to access the at least one network slice, prior to registering with the PLMN for the second tracking area.

12. The UE of claim 9, wherein the update message includes a configuration update command including a network slicing indication information element (IE) indicating the subscription change of the at least one network slice.

13. The UE of claim 9, wherein the update message includes a configuration update command message including network slicing configuration information indicating at least one of: an allowed network slice selection assistance information (NSSAI) and a configured NSSAI, and
wherein each NSSAI corresponds to the at least one network slice.

14. The UE of claim 9, wherein the at least one processor is further configured to:
transmit, to the AMF, a request to access the at least one network slice, wherein the UE is camped on the second tracking area from the plurality of tracking areas;
receive, from the AMF, a confirmation in response to the request from the AMF; and
register with the PLMN for the second tracking area, based on the confirmation.

15. The method of claim 1, further comprising:
registering with the PLMN for a second tracking area from the plurality of tracking areas;
receiving, from the AMF, a registration accept message including an indication indicating subscription change of the at least one network slice; and
removing the information on the first tracking area associated with the error from the list of forbidden tracking areas, based on the indication.

16. The UE of claim 8, wherein the at least one processor is further configured to:
register with the PLMN for a second tracking area from the plurality of tracking areas,
receive, from the AMF, a registration accept message including an indication indicating subscription change of the at least one network slice, and
remove the information on the first tracking area associated with the error from the list of forbidden tracking areas, based on the indication.
